(19) United States
(12) Patent Application Publication
(10) Pub. No.: US 2006/0087677 A1
(43) Pub. Date: Apr. 27, 2006

(54) Personal document management system

(76) Inventor: Vincent W. Maciejewski, Edmonton (CA)

Correspondence Address: Vincent W. Maciejewski, 256 Burton Road, Edmonton, T6R 1P3, CA

(21) Appl. No.: 10/906,369

(22) Filed: Feb. 16, 2005

Related U.S. Application Data
(63) Continuation-in-part of application No. 10/904,148, filed on Oct. 26, 2004.

(51) Int. Cl. G06F 3/12

(52) U.S. Cl. 358/1.15

(57) ABSTRACT

Disclosed is a personal document management computer system device comprising: an means to transfer documents from a personal computer to said device using a logical printer; a means to scan documents using a scanner peripheral device, said scanned documents being available for viewing on said device: a means to record handwriting written using a specially adapted writing device: a means to search handwritten notes given a handwritten search pattern.

### DESCRIPTION

Disclosed is a personal document management computer system device comprising one, some, or all of the following:

A means to transfer documents from a personal computer to said device using a logical printer;

A means to scan documents using a scanner peripheral device, said scanned documents being available for viewing on said device; and a means to display scanned documents on a low resolution display.

A means to record handwriting written using a specially adapted writing device;

A means to search handwritten notes given a handwritten search pattern;

A means to search handwritten notes given a typed alphanumeric search pattern.

In the last few years a number of portable devices have been marketed that can be synchronized with a personal computer. This synchronization usually takes place using a dedicated synchronization program.

In accordance with the first aspect of the invention disclosed is a method to easily transfer documents using the print function provided on most personal computers. The disclosed method comprises the following steps:
(1) providing a logical printer on said personal computer;
(2) printing a document to said printer;
(3) transferring data from said personal computer to another computer, wherein the second computer may be a PDA.

A logical printer is that what appears on the printers section of the user interface on a the computer. For example, on a personal computer running the Windows XP Professional operating system, all printers, logical and physical, can be seen by selecting “Printers and Faxes” from the start menu.

It will be obvious to one skilled in the art that a logical printer can be provided in a number of ways an all are intended to be covered by present disclosure.

It will be obvious to one skilled in the art that the second computer need not be connected at the time of printing and said printed information can be stored until said second computer is actually connected.

It will also be clear to one skilled in the art that there are a number of advantages of printing a document before transferring it to a second computer. When documents are printed, they are converted to a particular format consistent among all the printed documents; where such documents may have been stored in disparate formats originally. The main advantage of using a common format for all documents is that the second computer can be constructed such that it is adapted to read only one document format.

In accordance with another aspect of the present invention disclosed is a method of scanning using a short portable scanner whose scan width is shorter than the width or length of area that it can scan. The short length of the scanner makes it more portable. The shorter the length of the scanner the more portable the scanner becomes.

Definition List 1

| Term | Definition |
|---|---|
| Scanner | A device, possibly hand held, adapted to |
| | capture an image as it is passed over the |
| | image. |
| Scan line | The part of the scanner that is light |
| | sensitive. It may consist of multiple |
| | sensors. |
| Desired scan area | A page, or part of page, a piece of paper, |
| | or whatever area the user of the scanner |
| | desires to scan. |
| Partial scan | A scan that corresponds to part of the |
| | desired scan area being scanned. The |
| | desired scan area will typically require |
| | several partial scans. A partial scan is |
| | generated by passing the scanner over |
| | the desired scan area once. |

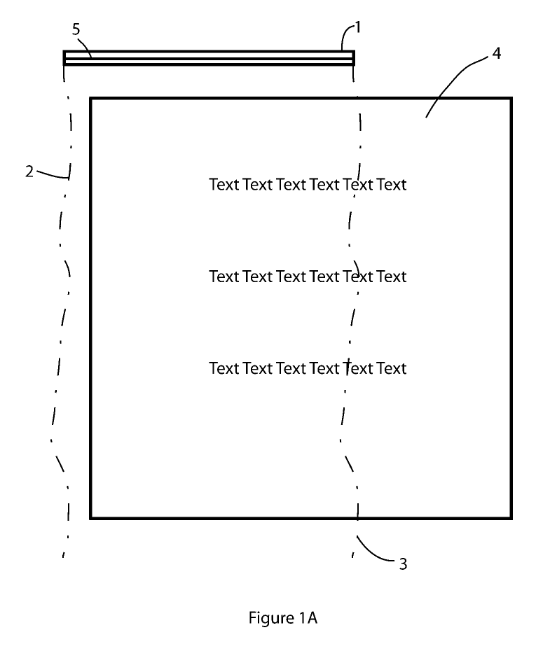

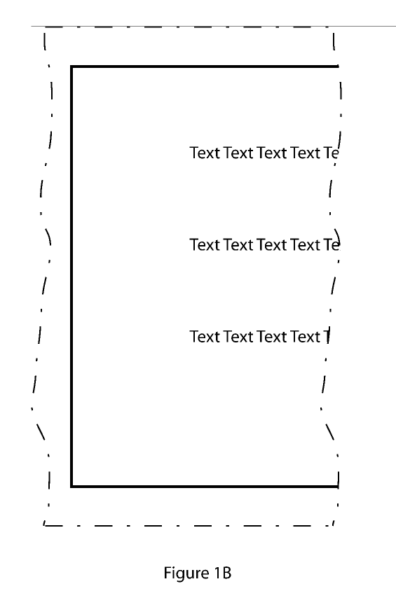

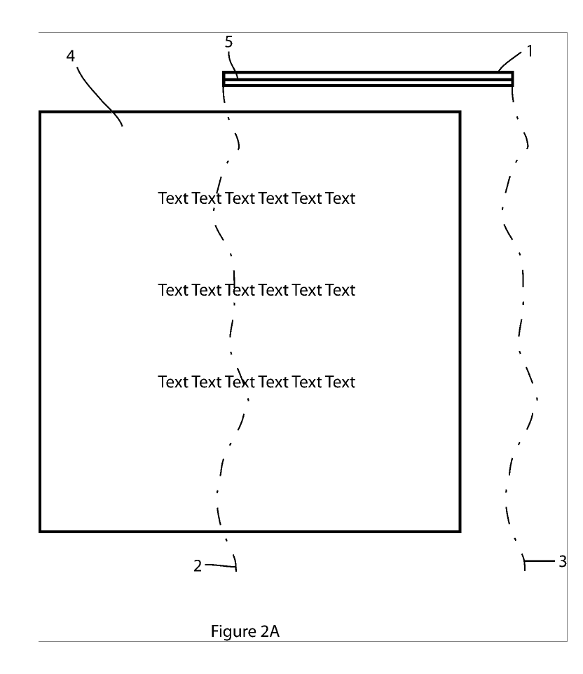

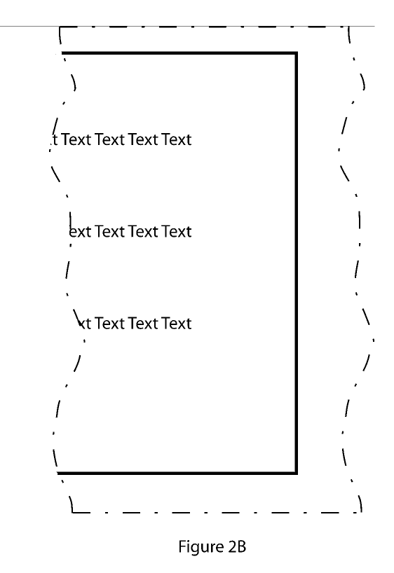

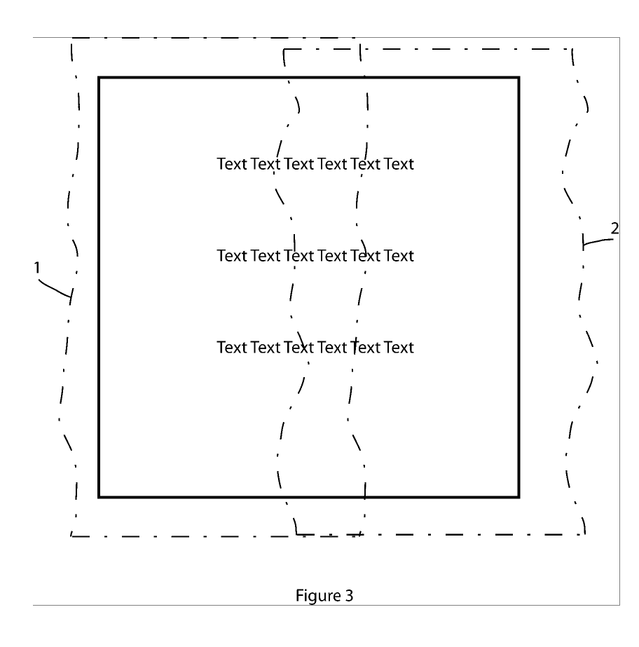

The scanning method disclosed here comprises several steps; each step involves passing the scanner from one edge of the desired scan area (DSA) to the other, for example, from top to bottom of the DSA. However, to scan a DSA that is wider then the scanner several partial scans are required. Once enough partial scans as to cover the whole DSA are performed, the individual images obtained from each partial scan are reconstructed together. More precisely, according to FIG. 1A, the following scanning method is disclosed:
(1) A scanner 1 with scan line 5 and placing said scanner near the desired scan area 4 is provided;
(2) The scanner is passed over scan area where the left edge of the scan line follows the exemplary imaginary dash-dotted line 2 and the right edge of the scan line follows the exemplary imaginary dash-dotted line 3; if the scanner is hand held the line followed may be irregular as exemplified in FIG. 1A, however, it is in the interest of the user to keep line 2 and 3 as straight as possible in order to enhance image quality, therefore, lines 2 and 3 in practice may be quite close to being straight; imagine captured by the first scan is shown in FIG. 1B;
(3) Since the image captured by the first partial scan does not cover the entire desired scan area 4 as shown in FIG. 1A, a second partial scan is performed (by the user off the scanner);
(4) According to FIG. 2A, the scanner 1 with scan line 5 is placed near the desired scan area;
(5) The scanner is passed over the DSA where left edge of the scan line follows the exemplary imaginary line 2 and right edge follows the exemplary imaginary line 3;
(6) The second partial scan is shown in FIG. 2B;
(7) If the desired scanned area has not yet been covered by all partial scans the user goes to step (3);
(8) Once enough images to cover the desired scan area have been captured a reconstruction algorithm is executed. The result of such an algorithm is a single image of the desired scan are composed of each of the partial scan images made as exemplified using two partial scan images in FIG. 3. In FIG. 3, the two captured partial scan images are reconstructed into one image using an image reconstruction algorithm described later.

It will be obvious to one skilled in the art that the lines traced out, or followed, by the left and right side of the scan line will not necessarily be parallel as shown in FIG. 1A and FIG. 2A since the scanner may be hand held. In that case the composite image scanned in may be slightly distorted.

It will be obvious to one skilled in the art that even though the attached figures show a scan area that requires two partial scans to be performed, the described method easily generalizes to larger desired scan areas that require more than two partial scans.

The disclosed method of scanning using a scanner shorter than desired scan area includes the provision of a reconstruction algorithm adapted to reconstruct the desired scan area from each of the partial scan images. Said algorithm can be designed in several ways as will be clear to one skilled in the art of computer science. One such implementation is described below, as an example, but all such reconstruction algorithms are intended to be covered by the present disclosure.

Assume that the partial scan images overlap at least partially. An algorithm to reconstruct the composite image comprises the following steps:
(1) Given two adjacent partial scan images of the desired scan area select one or more small subimages from one of the partial scan images, the first (left) one for example, and place each of the small subimages as elements into a collection data structure.
(2) Record the coordinates of each of the subimages in the left partial scan image.
(3) For each element in said subimage collection search the second partial scan image, the second (right) one for example, and find coordinates in the right partial scan image of each subimage if possible. The search will succeed if the subimages have been chosen to lay in the area where the left and right partial scan image overlap; at least two need to be found. It may also be necessary to rotate the search target as both of the adjacent partial scans may not have been made parallel to each other.
(4) Given that the coordinates of each element are known in the left image and the right image, both images can be matched into one.

It will be clear to one skilled in the art the above algorithm may have to be modified in the case where the two adjacent images include repeating patterns in the area of their overlap.

It will be clear to one skilled in the art that even though the above algorithm has been described for two partial scan images only it can be easily generalized to multiple partial scan images.

The method of scanning presented in this disclosure may additionally include two further steps: providing a means to notify the user of the scanner if the reconstruction algorithm fails, and providing a means to notify the user of the scanner if the reconstruction algorithm succeeds.

The method of scanning may additionally include the step of providing a display device adapted to displaying the reconstructed image of the desired scan area. Said device may be a personal computer, a personal digital assistant, a wireless phone, a wireless electronic messenger, or another device.

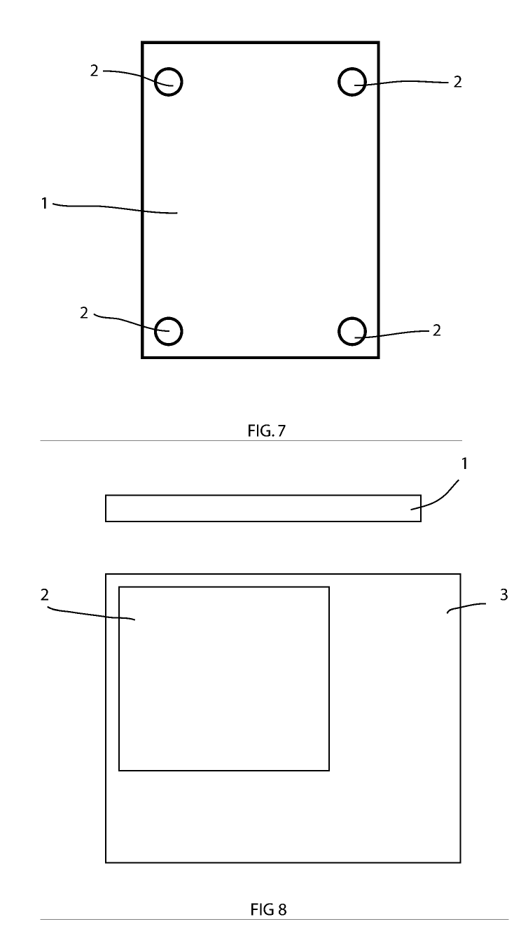

A scanned image will typically be larger in size then the number of pixels a portable display device will be able to display. Many cell phones and PDAs will have a display area that is less than 300 pixels across. A typical page that is scanned at 100 dots per inch will require about 800 pixels across in order to be displayed. Therefore, a method is disclosed to display images of scanned pages that contain a number of pixels across that is larger than the number of pixels across available display. Said method comprises the following steps, according to FIG. 8.:
Providing a portable scanning device 1;
providing a display 2 with n pixels across; said display may be attached, or be part of, a portable computing device;
providing an image 3 to be displayed on said display said image containing m pixels across, said image being scanned using a portable scanning device and transferred to a portable device adapted with a display; where m is greater than n.
displaying a portion of said image equal to or smaller than n.
providing a scrolling method on said device said scrolling method being adapted to move the visible area around the page.

It will be obvious to one skilled in the art that the scrolling method requires the implementation of a user interface. One way to implement said scrolling user interface is to provide scroll bars on said display. Another way is to provide scroll wheels.

In a further aspect of the present invention the scanning device may optionally comprise a memory that is accessible from a personal computer. For example, the scanning device may be connected to the personal computer using a USB cable and memory comprised within scanning device is made available as disk drive. This allows the user of the personal computer to transfer scans to the personal computer and also to store files on said scanning device. Said files can then be transferred to another computer or used as backup. It will be obvious to one skilled in the art that the personal computer may be replaced by a PDA or another computer.

In accordance with another aspect of the present invention, disclosed is a means to record handwriting using a specially adapted writing device.

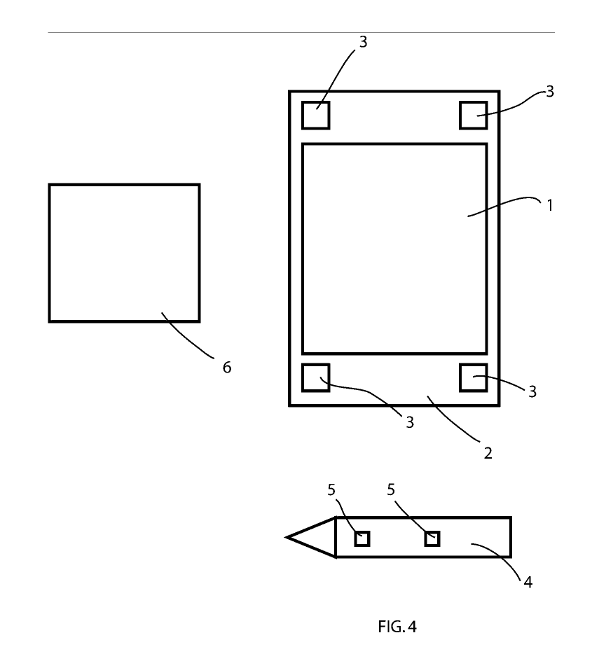

According to FIG. 4, there is provided a writing area 1, a plurality of transceivers 3 placed around or within or underneath the writing area on top of a base or plate 2, a plurality of transceivers 5 placed within a pen 4. Transceivers placed around the writing area being adapted to send or receive signals to or from transceivers located inside the pen, the signals being used to compute the position of the stylus.

There is further disclosed a notepad computer with a CPU and memory 6 adapted to communicate with said transceivers.

There is also provided a means to detect whether said pen and its stylus are pressed against said writing area. This may be accomplished using a pressure sensor placed within said pen or underneath said writing area. The pressure sensor operates in conjunction with a transmitter adapted to send status of the pressure sensor to said computer.

A method to transform pen movements into recorded data is disclosed and comprises the following steps:
(1) User picks up the pen.
(2) Notepad computer receives signals from transceivers placed on notepad base and determines a position of the stylus.
(3) When the user presses the stylus against the writing area the pen transmits a signal to the notepad computer indicating that the stylus is pressed.
(4) Once the signal that stylus has been pressed is received by the notepad computer the notepad computer records position of stylus in memory whenever the user moves the stylus.
(5) When the user lifts the stylus the pen transmits a signal to the notepad computer indicating that the stylus has been lifted.
(6) Once the signal indicating that stylus has been lifted is received by the notepad computer the computer stops recording position of the stylus.

When this method runs its course, recorded data is in form of a bit map. However, it will be obvious to one skilled in the art that computer handwriting recognition algorithms can be used in order to transform the bitmap into text that can be stored in digital form.

In accordance with the first preferred embodiment of the present invention, a means to determine the position of the pen with respect transceivers placed in the vicinity of the writing area is provided.

There are a number of methods or systems that can be used to facilitate the means to determine the position of the pen, and hence the stylus, and all such methods or systems are intended to be covered by the present disclosure. The following method is disclosed as an example.

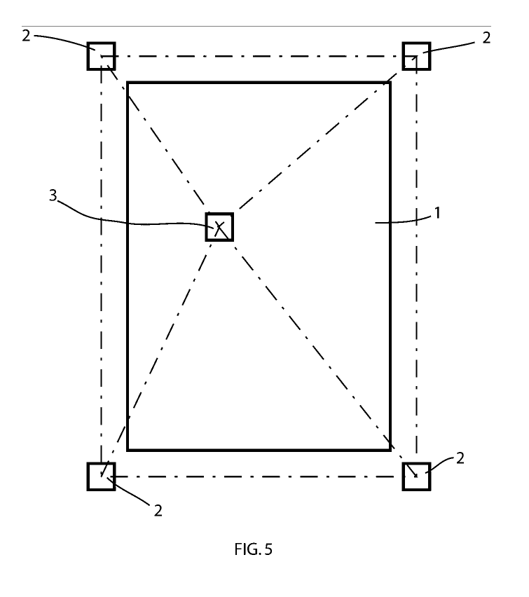

Once transmitters are placed inside the pen, the well known method of triangulation can be used. This method involves the placement of a plurality of receivers listening on signals from a transmitter placed inside the pen. The difference in time when signals are received by each of the receivers enables the computation of relative distance from each of the receivers and thereby determination of the position of the transmitter. For example, if two receivers receive a signal from a transmitter at the same time, then it can be determined that the distance from each of the receivers to the transmitter is equal. If one of the receivers receives the signal before the other receiver receives same signal, it can be determined that the transmitter is closer to the first receiver and it is known how much closer since the speed at which the signal travels is known. According to FIG. 5, it is enough to place four receivers 2 in the vicinity of the writing area 1 in order to determine the position (in three dimensions) of a transmitter 3 placed above the writing area. The coordinates of where the receivers are placed are well known. The transmitter will be placed inside a pen and will likely be positioned above the writing area. Since the position in three dimensions of the transmitter is described by three variables, and the distance to the receiver which first receives the signal is unknown, there are four unknowns that need to be solved for. It will be clear to one skilled in the art that in order to obtain four equations the construction of four triangles as shown by dashed lines in FIG. 5 will be sufficient.

It will be obvious to one skilled in the art the role of transmitters and receivers can be reversed to achieve a similar method of determining the position of the pen. Receivers can be placed inside the pen and transmitters can be placed around the writing area. Both arrangements are intended to be covered by this disclosure. Hence, throughout the disclosure, a transmitter or receiver is referred to using the more general term of transceiver.

A means to determine an accurate position of the stylus is provided.

There are a number of methods or systems that can facilitate the means to determine position of the stylus and all such methods or systems are intended to be covered by present disclosure.

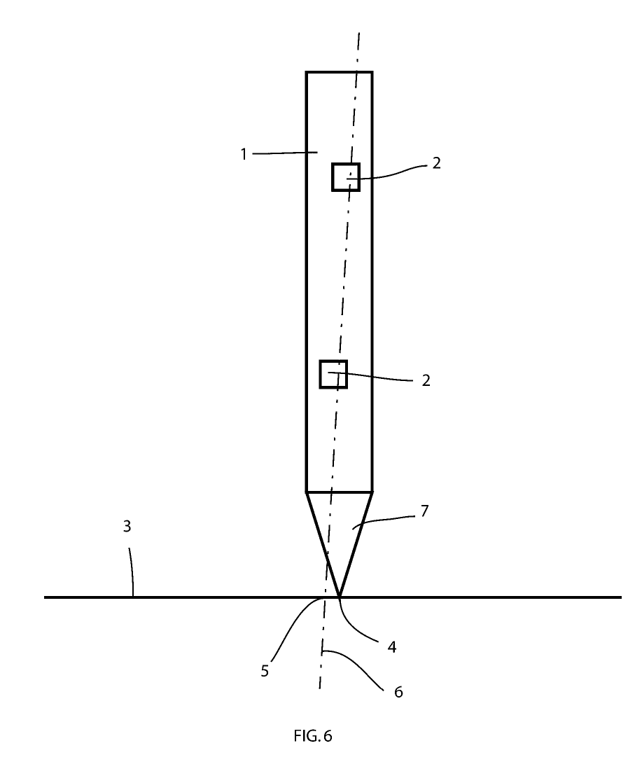

A system to determine an approximate position of the stylus is shown in FIG. 6. According to FIG. 6, placing two or more transceivers 2 inside a pen 1 will form an imaginary best fit straight line 6 through the transceivers once the position of the transceivers is determined. Given the length of the pen, it will be obvious to one skilled in the art that an approximate point 5 of where a stylus touches a writing area 3 can be determined. It will also be obvious to one skilled in the art that the approximate point will be at some distance from the exact point 4 of where the stylus 7 touches the sheet. It will also be obvious to one skilled in the art that increasing the number of the transceivers may reduce the distance the approximate point is from the exact point where stylus touches the sheet; hence improving accuracy of the approximation. It is practical to configure the transceivers inside the pen to be configured as transmitters; however, it is also possible to configure them as receivers.

In a further aspect present invention a method for determination of an accurate position of where the stylus touches the writing area is provided. It is important to be able to compute an accurate position of the stylus in order to achieve a good record in the computer memory to what is being written. There are a number of methods that can be used to determine accurate position of where the stylus touches the writing area; however, all are intended to be within the scope of the present disclosure.

One such method is the method of calibration, where several visible mark spaces are placed in well known positions on the writing area. For example, a page might have small squares or circles, or other mark spaces, placed in a plurality of locations on the page as shown in FIG. 7. Before starting to write, the user must mark in each of the mark spaces 2 printed or otherwise placed on writing area 1. The position of the mark spaces is well know and is recorded in the computer memory beforehand so that when the user marks the mark spaces the notepad computer will be able to record the difference between the well known mark space positions and the computed mark space positions. The difference between computed and actual position will in turn enable the notepad computer to find the offset from the recorded and the exact position of where the stylus touches the writing area. When the user marks each of the mark spaces the computer computes the error offset. It will be obvious to one skilled in the art that one or more mark spaces may be placed on the writing area and their position is arbitrary as long as their position is well known and available to the notepad computer. It will also be obvious to one skilled in the art that following the calibration procedure handwriting can be recorded using coordinates relative to edges of the writing area as opposed to coordinates relative to where the transceivers placed around the writing area; given that distance from mark spaces to edges is known.

A means to determine when the stylus touches the writing area is disclosed.

There a number of methods or systems that can facilitate a means to determine when the stylus touches the writing area and all are intended to be within the scope of the present disclosure.

The determination of when the pen actually touches the writing area can be done using at least two methods and all such methods are intended to be covered by the scope of the present disclosure. In the first method, a pressure sensor is placed inside the stylus or the body of the pen itself. When the sensor is activated a signal is sent to the notepad computer indicating that the stylus has touched the writing area. The signal is sent using a transmitter associated with the sensor. In the second method, a sensor is placed underneath the writing area. When the sensor is activated a signal is sent to the notepad computer indicating that the stylus touched the writing area.

In another aspect of the present invention there is disclosed an eraser at the end opposite the stylus. When the user rubs the eraser on the writing area, information underneath the eraser is removed from computer memory and the associated screen if the page is displayed. The intention to erase is determined by the notepad computer when the positions of the transceiver placed within the pen are reversed. That is, when the transceiver that is closest to the writing surface is found to be the transceiver that is now the farthest. It will also be obvious to one skilled in the art that it will be necessary to detect that the erasing end has touched the writing surface.

Handwritten documents can be stored in computer memory once said documents are scanned in or captured into computer memory by recording movements of a pen used to make said documents.

Therefore, a method to search digitized handwriting information is disclosed. Said method involves the steps of:
(1) providing handwritten digitized document stored in a computer memory;
(2) providing a handwritten search pattern;
(3) converting said hand written pattern into a digital representation, said conversion may be performed by scanning or another method;
(4) searching said handwritten digitized information and comparing it to said search pattern;
(5) once said search pattern matches exactly or is similar to a second pattern found inside said document a match, or hit, is presented to the user.

There are a number of ways two handwritten patterns can be compared in order to determine if they are sufficiently similar that a match can be declared. Once such method is described below as an example, however, all such methods are intended to be covered by the present disclosure.

Over the past two decades significant progress has been made in handwriting recognition algorithms. For example, such algorithms have been used to read postal addresses on post envelopes. These algorithms can also be applied to searching.

In the method disclosed above, said digitized handwritten document can be transformed into an ASCII representation using a handwriting recognition algorithm. Similarly said handwritten search pattern can be transformed into an ASCII representation using a handwriting recognition algorithm. After both transformations have been completed, the problem is reduced to searching for an ASCII text string in an ASCII document.

In a further aspect of the present invention, there is disclosed a method to search handwritten documents using an alphanumeric pattern.

Said method involves the steps of:
(1) providing handwritten digitized document stored in a computer memory;
(2) providing an alphanumeric search pattern;
(3) searching said handwritten digitized information and comparing it to said search pattern; once said search pattern matches exactly or is similar to a second pattern found inside said document a match, or hit, is presented to the user.

There are a number of ways a handwritten document can be searched using an alphanumeric pattern. One such method is described below as an example, however, all such methods are intended to be covered by the present disclosure.

Said digitized handwritten document can be transformed into an ASCII representation using a handwriting recognition algorithm. After the transformation has been completed, the problem is reduced to searching for an ASCII text string in an ASCII document.

What is claimed is:

1. A method of transferring data from first computer to a second computer comprising the following steps:
providing a first computer;
providing a second computer;
providing a logical printer available to applications for printing on said first computer;
printing a document from an application executing on said first computer to said printer;
transferring a document printed to said printer on said first computer to said second computer.

2. The method of [claim 1] wherein said first computer is a personal computer and said second computer is a hand held computer.

3. A method of scanning comprising the following steps:
providing a scanning device, said scanning device being lesser in length than width and length of a desired scan area;
passing said scanning device across said desired scan area more than once, recording a partial image from each scan pass;
providing an image reconstruction algorithm adapted to put said each partial scan image together into one image corresponding to said desired scan area.

4. Method of [claim 3] further comprising the step of providing an indication to user that said algorithm has succeeded.

5. Method of [claim 3] further comprising the step of providing an indication to user that said algorithm has failed.

6. Method of [claim 3] further comprising the step of providing a device adapted to displaying said desired scan area after scanning and reconstruction.

7. The method of [claim 3] further comprising the step of providing a memory within said scanning device, said memory being accessible from another computer such as a personal computer, said memory appearing as disk drive with a file system accessible on said personal computer, whereby files can be transferred between said scanning device and said personal computer.

8. A method of recording handwritten information comprising the steps of:
providing a writing area;
providing a plurality of first transceivers placed around or within or underneath said writing area.
providing a writing instrument comprising a stylus;
providing two or more second transceivers placed within said writing instrument;
providing a computer with a CPU and memory said computer adapted to communicate with said first transceivers.

9. The method of [claim 8] further comprising the step of computing the position of said second transceivers with respect to said first transceivers.

10. The method of [claim 9] wherein the method of computing position of said second transceivers is the method of triangulation.

11. The method of [claim 9] further comprising the step of determining the point of where said stylus touches said writing area using the position of said second transceivers.

12. The method of [claim 11] wherein the distance from each of the transceivers is used to determine the point where said stylus touches said writing area.

13. The system of [claim 8] further comprising:
special mark spaces marked on said writing area;
a means to compute first coordinates of said mark spaces with respect to edges of said writing area;
a means to use said writing instrument to write inside said mark spaces.

14. The system of [claim 13] further comprising:
a means to compute second coordinates of said mark spaces using said pen and said computer;
a means to adjust second coordinates to equal first coordinates;
whereby handwriting information can be recorded using a coordinate system relative to edges of said writing area.

15. The system of [claim 8] wherein said means to determine whether said stylus touches said writing area comprises:
a means of placing inside said pen a pressure sensor adapted to sensing if said stylus is pressed;
a means of placing inside said pen a transmitter adapted to transmitting the state of said pressure sensor.

16. A method to search digitized handwritten information comprising the following steps:
providing a digitized document;
providing a handwritten digitized search pattern;
searching said handwritten digitized document to determine where said search pattern is contained.

17. A method to search digitized handwritten information comprising the following steps:
providing a digitized document;
providing an alphanumeric search pattern;
searching said handwritten digitized document to determine where said search pattern is contained.

18. A personal document management device comprising:
a means to digitize paper documents;
a means to search said documents given a handwritten search pattern.

19. The system of [claim 18] further comprising a means to scan documents using a scanner peripheral device.

20. The system of [claim 18] further comprising a means to record handwriting written using a specially adapted writing device.

21. The system of [claim 18] further comprising:
a second computer:
a means to transfer documents from said second computer to said device using a logical printer available on said second computer.
